(19) United States
(12) Patent Application Publication
(10) Pub. No.: US 2010/0023256 A1
(43) Pub. Date: Jan. 28, 2010

(54) Process for Automatically Determining a Bypass Route

(75) Inventor: Hans L. Trautenberg, Ottobrunn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Taufkirchen (DE)

(21) Appl. No.: 12/505,954

(22) Filed: Jul. 20, 2009

(30) Foreign Application Priority Data
Jul. 21, 2008 (DE) 102008034201.7-54

(51) Int. Cl. G01C 21/36

(52) U.S. Cl. 701/201

(57) ABSTRACT

A navigation system automatically determines one or more bypass routes for a vehicle, based on a continuously determined vehicle position, according to a process having the following steps: receiving data concerning a hindrance in a region in the proximity of a current position; automatically determining one or more destinations which can be reached via the region affected by the hindrance; automatically determining additional regions via which the determined destinations can be reached; calculating an evaluation factor for each of the determined additional regions; and automatically determining one or more routes for bypassing the region affected by the hindrance, based on the evaluation factor.

### BACKGROUND AND SUMMARY OF THE INVENTION

This application claims the priority of German patent document 10 2008 034 201.7-54, filed Jul. 21, 2008, the disclosure of which is expressly incorporated by reference herein.

The present invention relates to a process for automatically determining a bypass route, and for navigating a vehicle over a determined bypass route.

Navigation systems are used in highway/street traffic, air traffic and water-borne traffic for assisting vehicle operators, pilots or captains. However, navigation systems which have not been activated (i.e., navigation systems without a programmed destination) do not output bypass recommendations when problematic regions appear on a route, such as traffic jams, bypasses, snow or water on roads, heavy swell or seas in the case of water-borne traffic, strong wind in air traffic or the like, or there is no landing possibility, no energy supply (no fueling possibilities), no parking possibilities and the like.

When a navigation system is not activated, a possible place of destination can automatically be determined, for example, by the statistical analysis of old routes stored in the navigation system. It is known, for example, from German Patent Document DE 10 2006 004 616 A1 to determine a bypass route in the case of a reported traffic disturbance even when no destination had been put into the navigation system. For this purpose, the navigation system automatically feeds back the previously driven route and determines a probability for the further traveling path based on the course of the previously driven route. If the probability for the further traveling path is correct, and a traffic disturbance is reported for the further traveling path or in its close surroundings, the navigation system will automatically search for a suitable bypass route.

However, the determination of a probability for the further traveling path may also present a problem when insufficient data are available concerning the course of previous driving routes. As a rule, this occurs, for example, immediately after the start of the drive. Another problem occurs when no recording of data of the previous driving routes is desired, or when a recording of data is even prohibited (for example, for legal reasons). A typical example of such a case is rental cars, where many users do not want any recording of driving routes.

It is therefore an object of the present invention to provide an improved process for automatically determining a bypass route which, in particular, avoids the above-described problems, and a method for operating a vehicle according to such a bypass route.

This and other objects and advantages are achieved by the method and system according to the invention in which, when a hindrance that affects a particular region is known or becomes known at a time when a vehicle navigation system is not activated, it is automatically determined whether a decision would have to be made at the moment, so that destinations which can most favorably be reached via the particular region when no hindrance is present, would be reached more advantageously by using other regions. If the automatic determination indicates that a decision would have to be made because the destination can more advantageously be reached by using other regions, one or more automatically determined bypass routes can be issued. Various criteria, such as saving time, saving energy and/or a better ecological balance, can be used for determining whether or not a decision has to be made.

According to an embodiment of the invention, a process is provided for automatically determining one or more bypass routes, and a position determination takes place at a suitable distance by means of a navigation system. The process includes the following steps:
receiving of data concerning a hindrance in a region (for example, in the proximity of a current position or a region which is not in the proximity of the current position);
automatically determining one or more destinations which can be reached via the region affected by the hindrance;
automatically determining additional regions via which the determined destinations can be reached;
calculating an evaluation factor for each of the determined additional regions; and
automatically determining one or more bypass routes for bypassing the region affected by the hindrance while taking into account the evaluation factor.

This process can be integrated in the operating system of a navigation system, and even without any explicit input of a navigation destination (i.e., when the navigation system is not activated) can actively assist a user in the event of hindrances. In particular, it can assist users who do not want to activate the navigation system for various reasons, for example, during very short drives or driving routes known to the user.

According to the invention, the position of the vehicle is determined at suitable distance intervals, such as for example, a continuous position determination. In addition, it is also conceivable to select a position determination that is adapted to the situation. Thus, for example, when a first of two exit ramps has been passed, no additional position determination will be necessary for a certain time.

According to an embodiment of the invention, an evaluation factor for a region can be calculated on the basis of saving time and/or energy, and/or on the basis of an ecological balance for a route through the region.

According to an embodiment of the invention, the determined region with the most favorable evaluation factor can be selected from all determined regions, and a route through the selected region is calculated for reaching at least one of the determined destinations.

According to a further embodiment of the invention, the one or more determined bypass routes can be emitted acoustically and/or visually, for example, by way of the display and loudspeaker of the navigation system or by way of the visual, acoustic or tactile output systems of systems connected with the navigation system.

In addition, according to an embodiment of the invention, the evaluation factor for a detour route can be emitted. As a result, a user can base his decision concerning a bypass route on the evaluation factor.

Furthermore, after the output of one or more bypass routes, according to a further embodiment of the invention, a selection input of a bypass route can be received and a navigation corresponding to the selected bypass routes can be acoustically and/or visually emitted by means of the navigation system. This allows a user to select a bypass route advantageous to him without revealing his destination.

In an embodiment, the invention also relates to a computer program for implementing the process according to the invention.

Another embodiment of the invention provides a computer program product comprising a machine-readable program carrier on which a computer program according to the invention is stored in the form of electronically and/or optically readable control signals.

Finally, an embodiment of the invention relates to a system for automatically determining one or more bypass routes, which is equipped for implementing a process according to the invention and as described above and has a navigation system constructed for a continuous position determination.

The determination of the bypass recommendation need not necessarily be carried out in the onboard unit of the navigation system, but may also take place by way of centrally provided or decentralized systems.

According to a further embodiment of the invention, the system can also be constructed for receiving data concerning a hindrance in a region in the proximity of a current position, by radio and/or by a receiving device. For example, the data may be received by way of a TMC (Traffic Message Channel), DAB (Digital Audio Broadcasting) and/or a DSRC (Dedicated Short Range Communication) channel.

Other objects, advantages and novel features of the present invention will become apparent from the following detailed description of the invention when considered in conjunction with the accompanying drawings.

### BRIEF DESCRIPTION OF THE DRAWINGS

The terms and assigned reference symbols contained in the attached list of reference symbols are used in the description, in the claims, in the abstract and in the drawings.

FIG. 1 illustrates a navigation situation, with a region in which a traffic hindrance is present, and adjacent regions for bypass routes which are determined by means of the process according to the invention; and

FIG. 2 is a flow chart of an embodiment of the process for automatically determining one or more bypass routes according to the invention.

### DETAILED DESCRIPTION OF THE DRAWINGS

In the following, identical and/or functionally identical elements may be provided with the same reference symbols.

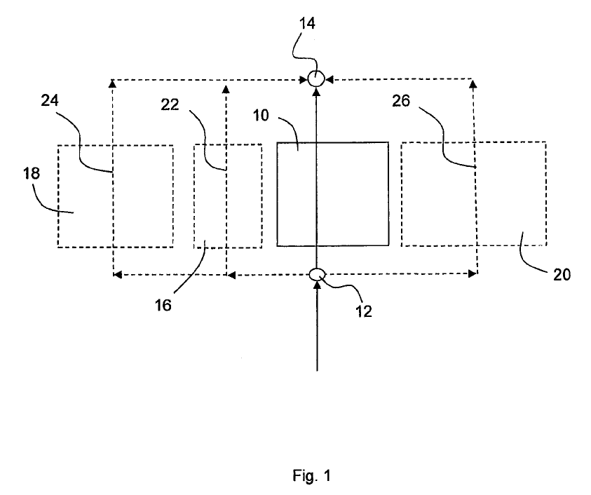

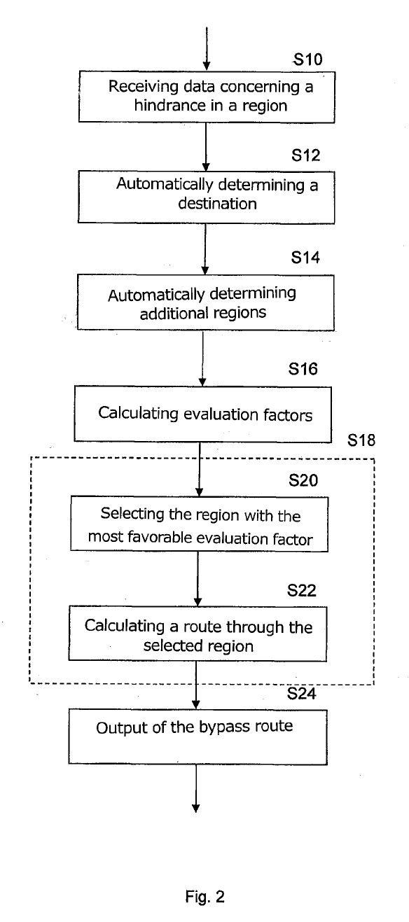

FIG. 1 illustrates a situation in which a region 10 with a traffic obstruction, such as a traffic jam, is situated in the proximity of the current position 12 of a vehicle. The driving direction of the vehicle is indicated by an arrow pointing upward to position 12. In a first process step S10, a navigation system, which is installed in the vehicle and which carries out the process according to the invention illustrated by the flow chart in FIG. 2, receives data indicating a traffic obstruction, via TMS, DAB or DSRC. The navigation system is not activated because no destination has been input; moreover, the navigation system is not fed back as in German patent document DE 10 2006 004 616 A1 such that the course of the previous driving route was recorded. Instead, no data concerning the previous driving route are stored in the navigation system, for the further driving route planning.

In a subsequent process step S12, the navigation system automatically determines a destination 14 that is favorable; that is, a destination that can be reached by a very short driving route via the region affected by the traffic hindrance. This destination 14 can, for example, by determined by means of the current vehicle position 12 and the current driving direction of the vehicle, or by means of the course of the road on which the vehicle is currently situated. The destination 14 can also be determined by means of a probability calculation in which, by means of various parameters, the destinations are determined for which the vehicle is headed with the highest probability. For example, the end of a road through the region 10 can be selected as the destination, which is the shortest route through the region, or a major road, an expressway or even a freeway or turnpike.

In the subsequent process Step S14, the navigation system determines further regions 16, 18 and 20 through which the destination 14 can be reached. Typically, the additional regions 16 and 20 neighbor the region 10 affected by the obstruction. The additional regions 16, 18 and 20 are not affected by any hindrance. The navigation system therefore determines only those regions to be additional regions which are appropriate for a conceivable bypass of the hindrance.

For each of the additional regions 16, 18 and 20, an evaluation factor will now be calculated in process Step S16. The calculation takes place according to the following criteria: By means of its available navigation data bank, the navigation system estimates the approximate time requirement for reaching the destination and the fuel consumption for each additional region 16, 18 and 20 and calculates the ecological balance for each additional region. The result may be, for example that the destination can be reached the fastest through the additional region 16, but only on an expressway with a minimum speed, so that the ecological balance will be poorer for this region than for the additional regions 20 via which, although the destination cannot be reached as rapidly, there are several local roads with a speed limitation with a relatively low fuel consumption, so that the ecological balance will be more favorable for this region. The evaluation factor will now be calculated based on the saving of time and energy, as well as the ecological balance.

After calculating the evaluation factors for each additional region 16, 18 and 20, in process Step S18 several bypass routes 22, 24, 26 through the additional regions 16, 18 or 20 are determined automatically for bypassing the region 10 affected by the obstruction while taking into account the evaluation factors calculated in Step S16. Step S18 has two steps S20 and S22 which are implemented successively.

First, in process Step S20, the region with the most favorable evaluation factor is selected (in the situation illustrated in FIG. 1, for example, the additional region 20). Then a bypass route 26 is calculated in process Step S22.

Step S18 can be carried out for each of the regions determined Step S14, so that a list with several bypass routes is obtained. This makes it possible for a user to select a preferred bypass route.

Finally, the navigation system emits the bypass route determined in Step S18 visually as well as acoustically in process Step S24, for example, by displaying the bypass route on a video screen of the navigation system and announcing the route by way of a loudspeaker system.

The invention is suitable not only for street/road traffic but also for water-borne and air traffic. Moreover, it is also especially suitable for all types of navigation systems, such as pedestrian navigation systems, if the latter can receive data concerning obstructions in regions, such as roads closed for traffic. According to the invention, no paths or routes need be recorded, which, on the one hand, permits a use from the very beginning and may, for example, be significant in the case of rental vehicles or in the case of demonstrations and tests. Furthermore, the invention will be particularly beneficial when a user is not willing to agree to a path or route recording.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

10 Region affected by a traffic hindrance

12 Current vehicle position

14 Probable driving destination

16,18,20 Additional regions

22,24,26 Bypass routes via additional regions

S10-S22 Process steps

S10 Receiving data concerning a hindrance in a region

S12 Automatically determining a destination

S14 Automatically determining additional regions

S16 Calculating evaluation factors

S20 Selecting the region with the most favorable evaluation factor

S22 Calculating a route through the selected region

S24 Output of the bypass route

What is claimed is:

1. A process for automatically determining at least one bypass route by which a vehicle can bypass a travel obstruction, based on a position determination that is performed at suitable distance intervals, by means of a navigation system, said process comprising:
said navigation system receiving data concerning an obstruction that affects a region ahead of the vehicle;
said navigation system automatically determining one or more destinations which can be reached via the region affected by the obstruction;
said navigation system automatically determining additional regions via which the determined destinations can be reached;
said navigation system calculating an evaluation factor for each of the determined additional regions; and
said navigation system automatically determining at least one bypass route for bypassing the region affected by the obstruction, taking into account the evaluation factor.

2. The process according to claim 1, wherein an evaluation factor is calculated for a particular region based on at least one of time saving, energy saving and an ecological balance for a route through the particular first region.

3. The process according to claim 1, wherein said step of automatically determining a bypass route comprises:
selecting a determined region with the most favorable evaluation factor of all determined regions; and
calculating a route through the selected region for reaching at least one of the determined destinations.

4. The process according to claim 1, wherein one or more determined bypass routes are acoustically or visually emitted.

5. The process according to claim 4, wherein the evaluation factor concerning a bypass route is emitted in addition to the bypass route itself.

6. The process according to claim 4, wherein, after output of at least one bypass route, an input selection of a bypass route is received and an acoustic or visual output of a navigation corresponding to the selected bypass routes takes place by means of the navigation system.

7. A computer program product containing a machine-readable program carrier on which a computer program is stored in the form of electronically and/or optically readable control signals, for causing a computer to perform the following steps:
receiving data concerning an obstruction that affects a region ahead of the vehicle;
automatically determining one or more destinations which can be reached via the region affected by the obstruction;
automatically determining additional regions via which the determined destinations can be reached;
calculating an evaluation factor for each of the determined additional regions; and
automatically determining at least one bypass route for bypassing the region affected by the obstruction, taking into account the evaluation factor.
